(19) United States
(12) Patent Application Publication
(10) Pub. No.: US 2025/0231529 A1
(43) Pub. Date: Jul. 17, 2025

(54) TIMEPIECE MOVEMENT COMPRISING A DEVICE FOR DISPLAYING AT LEAST TWO TIME ZONES

(71) Applicant: PARMIGIANI FLEURIER S.A., Fleurier (CH)

(72) Inventors: Guido TERRENI, Fleurier (CH); Guillaume LEWIS, Fleurier (CH); Laurent WIEDERRECHT, Meyrin (CH); Mathieu PAWLAK, Fleurier (CH); Michel PARMIGIANI, Fleurier (CH)

(21) Appl. No.: 18/849,332

(22) PCT Filed: Mar. 13, 2023
(86) PCT No.: PCT/IB2023/052401

§ 371 Date: Sep. 20, 2024

(30) Foreign Application Priority Data
Mar. 25, 2022 (CH) CH000333/2022

(51) Int. Cl. G04B 19/23; G04B 27/00

(52) U.S. Cl. CPC G04B 19/23; G04B 27/005

(57) ABSTRACT

A timepiece movement comprising a device for displaying the time in at least two time zones, the display device comprising a minute display member, a member for displaying the current hour representing a first time zone, a member for displaying the local hour representing a second time zone, the member for displaying the current hour and the member for displaying the local hour being superimposed, the movement further comprising a mechanism for setting the time in the second time zone, arranged to move the member for displaying the local hour, and a mechanism for synchronizing the member for displaying the current hour and the member for displaying the local hour, arranged to reposition the member for displaying the local hour so as to be superimposed with the member for displaying the current hour in order to leave only one hour-indicating member visible.

The present invention relates to the field of timepieces, and more particularly to a timepiece movement comprising a device for displaying at least two time zones.

It is known from the prior art that timepiece movements are designed to display a plurality of time zones.

EP2008159 describes a wristwatch with a switching mechanism capable of selectively displaying the time in either of two time zones on a single display. The single hour hand selectively displays either the local hour or the time in the second time zone, at the touch of a button. The switching mechanism comprises a heart-shaped cam and two levers. The offset between local hour and the hour in the second time zone is determined by the relative position of one lever to the other.

One of the disadvantages of the described switching mechanism is that it includes mechanisms for display selection and adjustment that are very complex, involving two differentials and a very large number of components.

On the other hand, known dual time-zone mechanisms can advance from hour to hour, half-hour to half-hour, or to the nearest minute, without a reset mechanism.

Depending on the mechanism, the standard requires corrections equivalent to twelve or twenty-four steps to cover the full 360° and return to the initial position.

CN101685292A describes a mechanism for displaying two time zones with the second time zone being corrected by means of a ring gear. This mechanism does not allow for easy time zone correction by incremental advancement of the hand displaying the current hour. On the other hand, resetting the second time zone and setting the time is more complex and time-consuming.

CH687494B5 describes a mechanism for displaying two time zones, for which the second time zone is corrected by means of a pusher. Resetting the second time zone is time-consuming, as it requires that the number of hours to be adjusted be set incrementally.

Others, such as one of the applicant's products, offer a dual time-zone mechanism that can be adjusted to the minute, allowing correction in both directions via an independent time-mechanism stem.

The aim of the present invention is to provide a timepiece movement with at least two time zones embedded in the center of the movement to take over its driving force and enable it to be reset at any time.

In the present case, the complication is constantly rotating with the current hour and therefore completes 360° in twelve or twenty-four hours, which renders the traditional correction and reset principles unusable without the arrangement of the present invention.

In accordance with the invention, a timepiece movement comprising a device for displaying the time of at least two time zones comprises:
a minute display member;
a member for displaying the current hour representing a first time zone; and
a member for displaying the local hour representing a second time zone;
the members for displaying the current and local hour are superimposed.

The movement further comprises:
a mechanism for setting the time in the second time zone, arranged to move the member for displaying the local hour, and
a mechanism for synchronizing the member for displaying the current hour and the member for displaying the local hour, arranged to reposition the member for displaying the local hour so as to be superimposed with the member for displaying the current hour in order to leave only one hour-indicating member visible.

In one embodiment, the mechanism for setting the time in the second time zone comprises an hour wheel of the member for displaying the local hour, cooperating with an hour wheel carrying the member for displaying the current hour, a jumper spring being arranged on the hour wheel of the member for displaying the local hour to drive a center wheel carrying the member for displaying the local hour.

Preferably, the mechanism for setting the time in the second time zone comprises a rocker designed to drive the center wheel.

In one embodiment, the mechanism for synchronizing the current hour and local hour displays comprises a further rocker cooperating with the wheel driving a jumper spring arranged to cooperate with a star wheel pressing on a heart-shaped cam driving the synchronization of the current hour and local hour displays when said synchronization mechanism is actuated.

In a preferred embodiment, the movement comprises a first control member arranged to move the member for displaying the local hour by one-twelfth of a revolution or by one twenty-fourth of a revolution each time said control member is actuated.

In one embodiment, the movement comprises a second control member arranged to synchronize, on each actuation of said second control member, the member for displaying the current hour and the member for displaying the local hour, the member for displaying the local hour moving in either direction towards the member for displaying the current hour by the shortest distance.

The features of the invention will become clearer upon reading the description of one embodiment given only by way of example, which is in no way limiting with reference to the schematic figures, wherein:

FIG. 1 shows a timepiece comprising a display of two time zones according to the present invention;

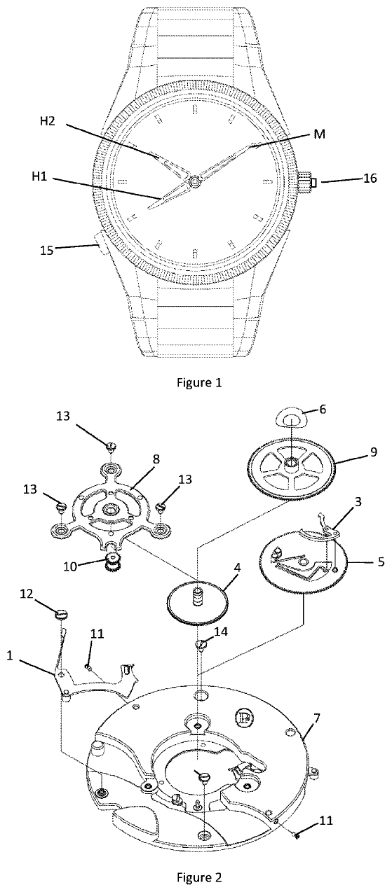

FIG. 2 shows an exploded view of a part of the movement according to the present invention;

FIG. 3 shows an exploded view of the rear part of the movement shown in FIG. 2;

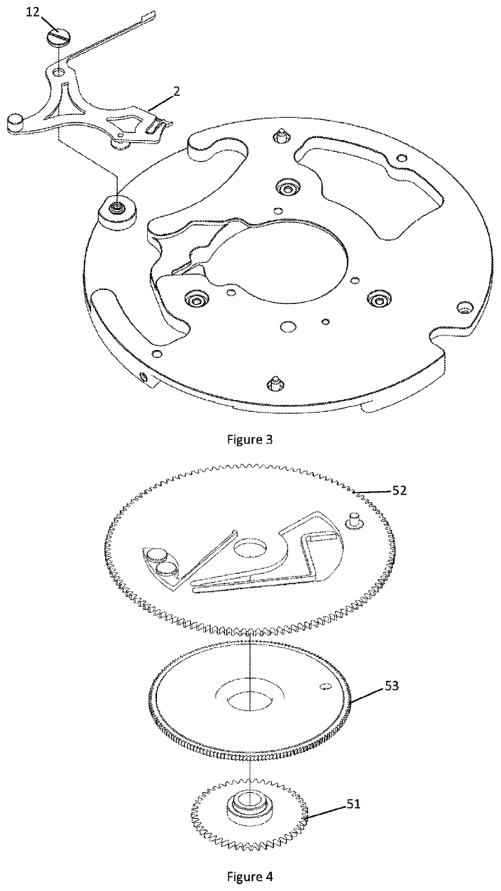

FIG. 4 shows an exploded view of the hour wheels arranged in the movement to display the hours of each time zone;

FIG. 5 shows an exploded view of a center wheel;

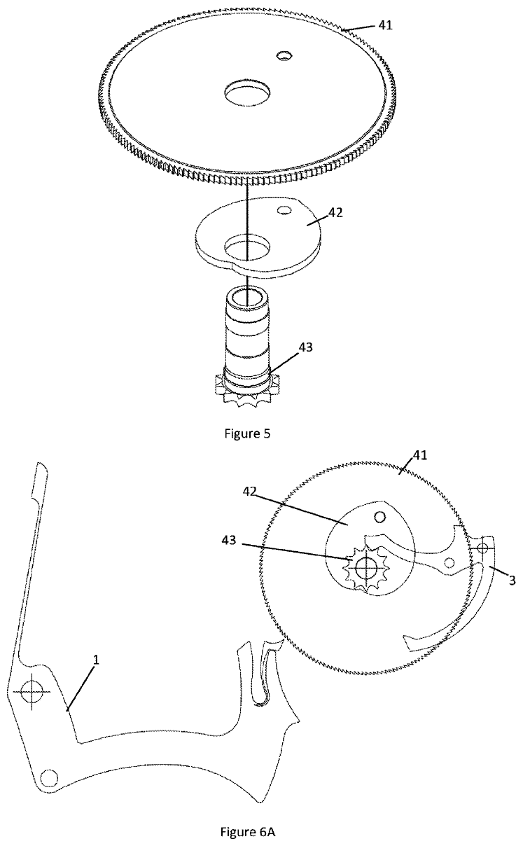

FIG. 6A shows a view of the mechanism for correcting the hours at rest;

FIG. 6B shows a view of the mechanism for correcting the hours in action;

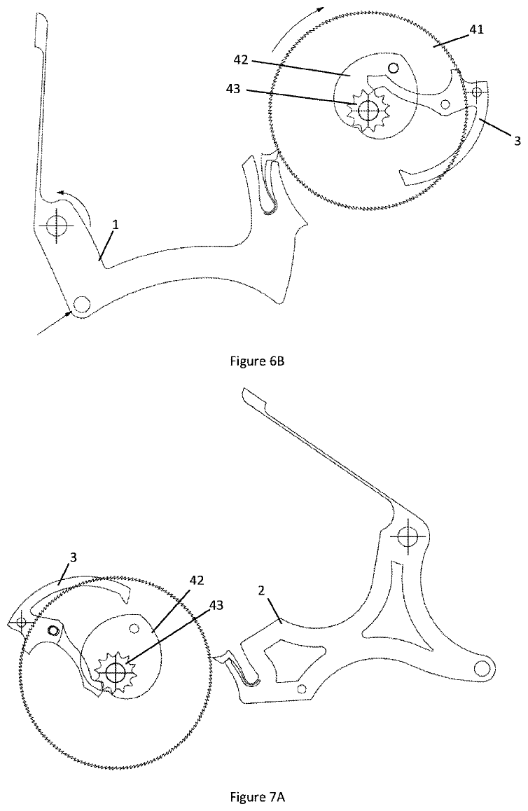

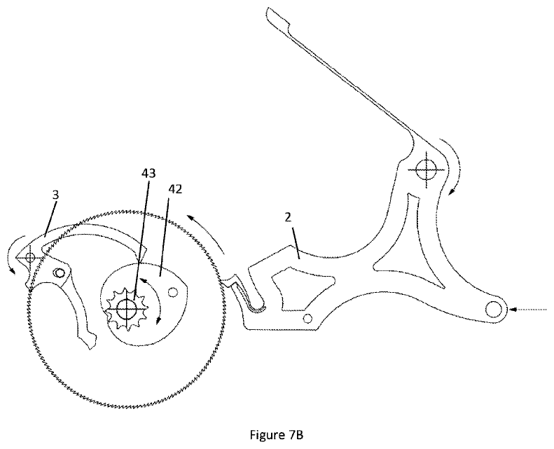

FIG. 7A shows a view of the mechanism for synchronizing the hour hands at rest; and

FIG. 7B shows a view of the mechanism for synchronizing the hour hands in action.

As shown in FIG. 1, a timepiece features a device for displaying the hour in two time zones. The display device comprises:
A display member in the form of a minute hand M;
A member for displaying the current hour in the form of a current hour hand H1 representing a first time zone;
A member for displaying the local hour in the form of a local hour hand H2 representing a first time zone.

The hands for the current hour H1 and local hour H2 are superimposed and positioned at the center of the movement, coaxially and displaying a two-hour time difference between the current hour H1 and local hour H2.

In the example shown, the hands for the current hour H1 and local hour H2 are positioned one above the other so that they coincide when only the current hour H1 is to be displayed. The movement further comprises a mechanism for setting the time in the second time zone, arranged to move the local hour hand H2, and a mechanism for synchronizing the current hour H1 and local hour H2 hands designed to reposition the local hour hand H2 superimposed with the current hour hand H1 so as to leave only one hand H1, H2 visible.

As illustrated in FIGS. 2 to 5, the mechanism for setting the time in the second time zone comprises an hour wheel 52 for the local hour hand cooperating with an hour wheel 9 carrying the current hour hand, a jumper spring 3 being arranged on the hour wheel 52 for the local hour hand to drive a center wheel 4 carrying the local hour hand H2.

The hour wheel 52 of the local hour hand is press-fitted onto the hour wheel of the movement 51. This hour wheel 52 sends the information back to the hour wheel 9 carrying the current hour hand, via a return 10.

The jumper spring 3 is mounted on the hour wheel of the local hour hand and drives a center wheel 4, which carries the local hour hand.

In our example, in order to correct the time by two hours, the push-button 15 (see FIG. 1) is pressed twice in succession, activating the rocker 1 (see FIGS. 6A and 6B). This rocker 1 drives the center wheel 4 one step equal to one-twelfth of a turn each time the push-button is pressed.

As illustrated in FIGS. 6A, 6B, 7A and 7B, the mechanism for synchronizing the current and local hour hands comprises another rocker 2 cooperating with the wheel 53 (see FIG. 4) driving a jumper spring 3 (see FIG. 2) arranged to cooperate with a star wheel 43 pressing on a heart-shaped cam 42 driving the synchronization of the current and local hour hands when said synchronization mechanism is actuated by pressure on the push-button 16 positioned on the winding crown of the timepiece.

The push-button 16 is arranged to synchronize the current hour hand and the local hour hand each time it is actuated, with the local hour hand moving in either direction towards the current hour hand by the shortest distance.

In our example, pressing the push-button 16 on the winding crown will move the local hour hand counter-clockwise until it is aligned with the current hour hand.

The complication rotates constantly with the current hour and therefore completes 360° in 12 hours.

According to the present invention, like a rattrapante mechanism, the hour hands are synchronized but can be desynchronized in the clockwise direction, then, if necessary, catch up to the position of the current hour hand in one direction or the other via a heart-shaped cam which defines the shortest path.

The present invention therefore makes it possible to display a second time zone embedded in the center of the movement to take over its driving force, and enable it to be reset at any time.

1. A timepiece movement comprising a device for displaying the time in at least two time zones, the display device comprising:
a minute display member (M);
a member (H1) for displaying the current hour representing a first time zone and a member (H2) for displaying the local hour representing a second time zone, the member (H1) for displaying the current hour and the member (H2) for displaying the local hour being superimposed;
a mechanism for setting the time in the second time zone, arranged to move the member for displaying the local hour (H2), and
a mechanism for synchronizing the member for displaying the current hour (H1) and the member for displaying the local hour (H2), arranged to reposition the member for displaying the local hour (H2) so as to be superimposed with the member for displaying the current hour (H1) in order to leave only one hour-indicating member (H1, H2) visible
wherein
a control member arranged to synchronize, on each actuation of said second control member, the member for displaying the current hour (H1) and the member for displaying the local hour (H2), the member for displaying the local hour (H2) moving in either direction towards the member for displaying the current hour (H1) by the shortest distance.

2. The movement according to claim 1, wherein the mechanism for setting the time in the second time zone (H2) comprises an hour wheel of the member for displaying the local hour (H2), cooperating with an hour wheel carrying the member for displaying the current hour (H1), a jumper spring being arranged on the hour wheel of the member for displaying the local hour (H2) to drive a center wheel carrying the member for displaying the local hour (H2).

3. The movement according to claim 2, wherein the mechanism for setting the time in the second time zone (H2) comprises a rocker arranged to drive the center wheel.

4. The movement according to claim 3, wherein the mechanism for synchronizing the current hour (H1) and local hour (H2) displays comprises a further rocker cooperating with the wheel driving a jumper spring arranged to cooperate with a star wheel pressing on a heart-shaped cam driving the synchronization of the current hour (H1) and local hour (H2) displays when said synchronization mechanism is actuated.

5. The movement according to claim 1, comprising a control member arranged to move the member for displaying the local hour (H2) by one-twelfth of a revolution or by one twenty-fourth of a revolution each time said control member is actuated.

6. The movement according to claim 2, wherein the hour wheel of the movement is press-fitted onto the hour wheel of the local hour display (H2).

7. A timepiece comprising a movement according to claim 1.
